(19) United States
(12) Patent Application Publication
(10) Pub. No.: US 2026/0122209 A1
(43) Pub. Date: Apr. 30, 2026

(54) DISPLAY SYSTEM WITH PRIVACY BASED ON VIEWER POSITION

(71) Applicant: Intel Corporation, Santa Clara, CA (US)

(72) Inventors: Roland Peter Wooster, Folsom, CA (US); Michael Millsap, Chandler, AZ (US); Geethacharan Rajagopalan, Gold River, CA (US)

(21) Appl. No.: 19/431,421

(22) Filed: Dec. 23, 2025

(51) Int. Cl. H04N 13/133; H04N 13/117; H04N 13/30; H04N 13/32; H04N 13/324; H04N 13/383; H04N 13/388

(52) U.S. Cl. CPC H04N 13/133; H04N 13/117; H04N 13/32; H04N 13/324; H04N 13/383; H04N 13/388; H04N 2013/40

(57) ABSTRACT

A display system includes a display including a front display layer and a rear display layer, and a processor configured to receive an original image comprising a plurality of pixels, each pixel having a pixel value. The processor is configured to, for each pixel of the original image, assign a first value to the front display layer and a second value to the rear display layer, wherein one of the first value or the second value is a randomized value and the other of the first value or the second value is determined based on the randomized value and the pixel value. The processor is configured to cause the front display layer and the rear display layer to display respective images based on the assigned values, wherein the respective images are aligned based on a position of a viewer relative to the display.

### TECHNICAL FIELD

The present disclosure relates to display systems, and more particularly to a multi-layer display system that provides real-time screen privacy by randomizing luminance distribution between front and rear display layers to prevent off-axis viewers from perceiving displayed content.

### BACKGROUND

Display technologies have evolved to include dual-layer configurations in which a front and a rear display layer are stacked. In such configurations, light from both layers combines to produce a composite image visible to a viewer. These dual-layer display systems have been applied in glasses-free three-dimensional display implementations, where the separation between layers and controlled pixel illumination create depth-perception effects.

Three-dimensional display systems using dual-layer configurations typically incorporate eye-tracking cameras to determine the viewer's position relative to the display. The camera detects the viewer's eye location and calculates the angular relationship between the viewer and various portions of the display surface. This positional information enables the system to account for parallax effects that arise from the physical separation between the front and rear display layers.

Screen privacy remains a consideration for users of portable computing devices and displays in public or shared environments. Conventional approaches to screen privacy include physical privacy filters that attach to display surfaces. These filters typically employ optical collimation to restrict the viewing angle, making the displayed content visible primarily to viewers directly in front of the screen while obscuring it for those at off-axis positions. However, such physical filters can be inconvenient to transport and may become damaged during handling or storage.

Alternative approaches to screen privacy include electronically adjustable privacy systems integrated into displays. These systems may affect display characteristics such as contrast or light transmission even during normal operation when privacy features are not activated. Accordingly, there remains interest in display privacy approaches that leverage existing display hardware configurations.

### BRIEF DESCRIPTION OF THE FIGURES

Non-limiting and non-exhaustive examples are described with reference to the following figures.

FIG. 1 depicts a display system using a dual-layer display configuration, according to aspects of the disclosure.

FIGS. 2A-2C illustrate a target viewer's views showing luminance combinations from front and rear display layers.

FIG. 3 illustrates a block diagram of a display privacy system for real-time display privacy, according to aspects of the disclosure.

FIG. 4 depicts target and spy viewer views illustrating image processing for the dual-layer display system of FIG. 1, according to aspects of the disclosure.

FIG. 5 illustrates a block diagram of a compute device, according to aspects of the disclosure.

### DETAILED DESCRIPTION

The following description sets forth exemplary aspects of the present disclosure. It should be recognized, however, that such a description is not intended as a limitation on the scope of the present disclosure. Rather, the description also encompasses combinations and modifications to those exemplary aspects described herein.

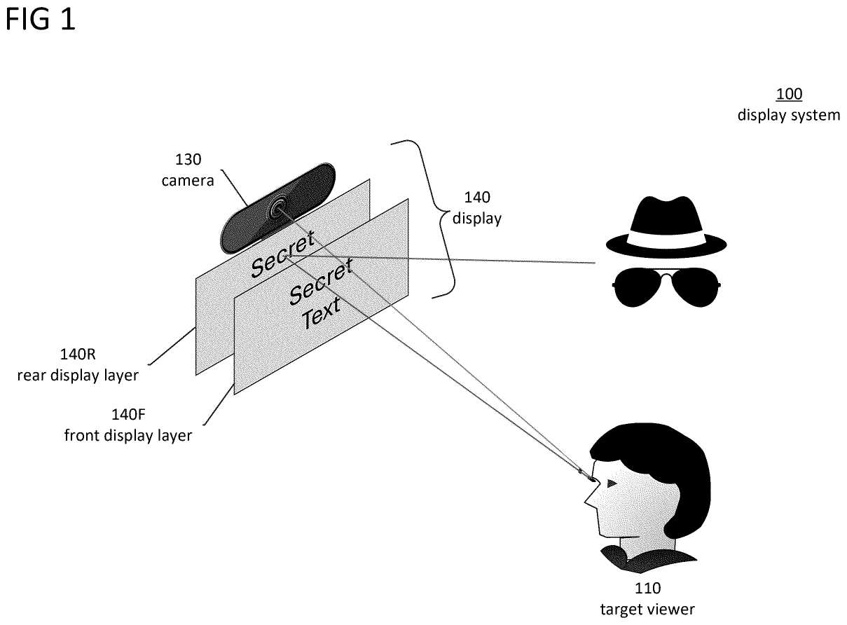

Referring to FIG. 1, a display system 100 represents a known dual-layer display configuration used for glasses-free three-dimensional (3D) displays. The display system 100 includes a display 140 having a front display layer 140F and a rear display layer 140R. The front display layer 140F may be semi-transparent to allow light from the rear display layer 140R to pass through. The rear display layer 140R may be black-based to provide contrast when combined with the semi-transparent front display layer 140F. A camera 130 may be positioned at a top portion of the display 140 and may be configured to detect the position of a target viewer 110 relative to the display 140.

With continued reference to FIG. 1, the known 3D system uses eye tracking via the camera 130 to calculate parallax between the target viewer 110 and each portion of the display 140. The camera 130 may detect the angle of the target viewer's eyes relative to the display 140 and calculate angular offset for left and right eyes of the target viewer 110. Based on the calculated position, the display system 100 may adjust the front display layer 140F and the rear display layer 140R such that images on both layers are aligned for the target viewer 110. A spy viewer 120 may be positioned off-axis from the target viewer 110. Due to the spatial separation between the front display layer 140F and the rear display layer 140R, the spy viewer 120 viewing from an off-axis position may perceive misaligned content from the two layers.

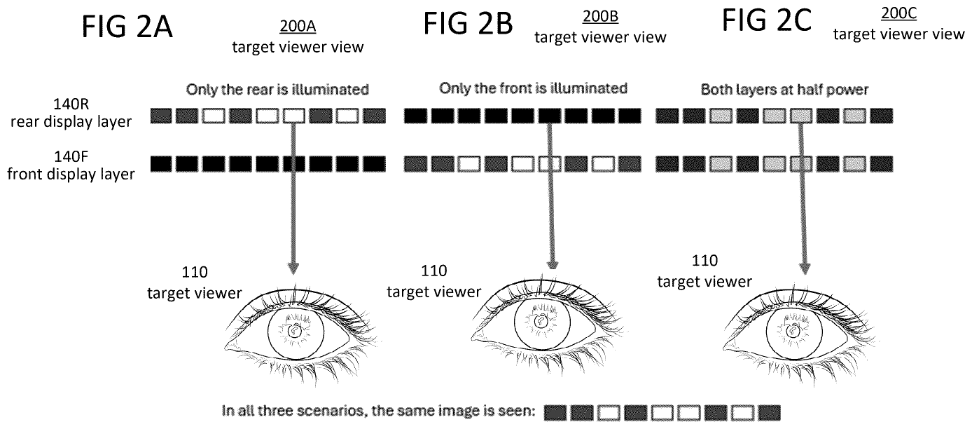

Referring to FIGS. 2A-2C, a target viewer's view illustrates known concepts demonstrating how an image experienced by a viewer is the sum of luminance from the front display layer 140F and the rear display layer 140R. FIGS. 2A-2C depict three scenarios 200A-200C using a dual-layer array of nine pixels to show that the distribution of luminance between the front display layer 140F and the rear display layer 140R does not affect the final image perceived by a target viewer 110, provided the combined luminance remains constant.

In a first scenario 200A shown in FIG. 2A, a target viewer 110 views the display 140 when only the rear display layer 140R is illuminated, while the front display layer 140F remains black. The rear display layer 140R displays an alternating pattern of dark blue and yellow pixels, and the target viewer 110 perceives this pattern as the resulting image.

In a second scenario 200B shown in FIG. 2B, a target viewer 110 views the display 140 when only the front display layer 140F is illuminated, while the rear display layer 140R remains black. The front display layer 140F displays the same alternating pattern of dark blue and yellow pixels, and the target viewer 110 perceives an identical resulting image to that perceived by the target viewer 110.

With reference to FIG. 2C, in a third scenario 200C, a target viewer 110 views the display 140 when both the rear display layer 140R and the front display layer 140F operate at half power. Each layer displays a muted version of the pixel pattern, and the target viewer 110 in this third scenario 200C perceives the same resulting image as the target viewer 110 in the second scenario 200B and in the first scenario 200A. The target viewer's view demonstrates that, regardless of how luminance is distributed between the front display layer 140F and the rear display layer 140R, the final image perceived by the target viewer remains identical when the combined luminance is the same.

The luminance experienced by a target viewer 110 may be expressed by the formula L=L_{f}+Lᵣ, where L represents the total luminance perceived by the target viewer, L_{f} represents the luminance of the front display layer 140F, and Lᵣ represents the luminance of the rear display layer 140R. For standard dynamic range (SDR) applications, the target luminance value L is typically between 0 and 1, whereas high dynamic range (HDR) values may exceed 1. The target viewer's views as shown in FIGS. 2A-2C confirm that on a per-pixel basis, the pixel luminance and color experienced by a target viewer 110 is the sum of the luminance of the relevant pixels from both the front display layer 140F and the rear display layer 140R.

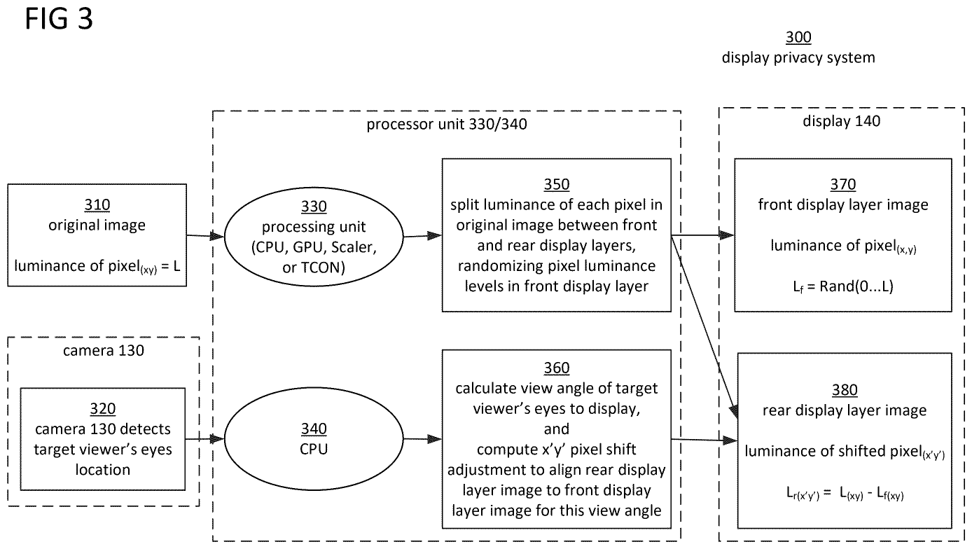

Referring to FIG. 3, a display privacy system 300 provides real-time display privacy using the dual-layer display configuration described with reference to FIG. 1. The display privacy system 300 includes the camera 130, a processor unit 330/340, and the display 140.

An original image 310 includes pixel data, where the luminance of each pixel at coordinates (x, y) is represented by L. For standard dynamic range (SDR) applications, the target luminance L may range from 0 to 1. For high dynamic range (HDR) applications, the target luminance L may exceed 1. The original image 310 is provided to the processor unit 330 for processing.

With continued reference to FIG. 3, the processor unit 330 may be implemented as a graphics processing unit (GPU), a central processing unit (CPU), a scaler, a timing controller (TCON), or other hardware or software computation components. The processor unit 330 performs the operations described in step 350. In some implementations, the randomization and computation logic may be implemented in hardware as part of graphics hardware. In some implementations, the randomization and computation logic may be implemented in hardware in display scaler hardware. In some implementations, the randomization and computation logic may be implemented via software in a graphics driver.

Step 320 involves the camera 130 detecting the target viewer's eye locations. The camera 130 determines the target viewer position, including the distance between the target viewer 110 and the display 140 and the target viewer's 110 viewing angle relative to different parts of the display 140. This information is provided to the CPU 340, which performs the operations described in step 360.

As further shown in FIG. 3, the step 360 calculates the view angle of the target viewer's eyes to the display 140 and computes an x′y′ pixel shift adjustment to align the rear layer display image 380 to the front layer display image 370 for the calculated view angle. The display privacy system 300 calculates parallax between the target viewer's eyes and each portion of the display 140 based on the camera-determined position. The display privacy system 300 determines which point of the display 140 the target viewer 110 is perpendicular to, both horizontally and vertically.

Step 350 involves splitting the luminance of each pixel in the original image 310 between the front display layer 140F and the rear display layer 140R while randomizing pixel luminance levels in the front display layer 140F. The luminance randomization for the front layer display image 370 is performed using the formula L_{f}=Rand(0 . . . . L), where L is the target luminance. The output of step 350 is the front layer display image 370, where the luminance of each pixel at coordinates (x,y) is set to a random value between 0 and L.

With continued reference to FIG. 3, the output of step 360 is the rear layer display image 380. The luminance for the rear layer display image 380 is computed using the formula Lᵣ(x′y′)=L(xy)−L_{f}(xy) to ensure the combined luminance equals the target luminance. This configuration ensures that the target viewer 110 sees the correct combined luminance from the front layer display image 370 and the rear layer display image 380 while off-axis viewers perceive randomized signal noise.

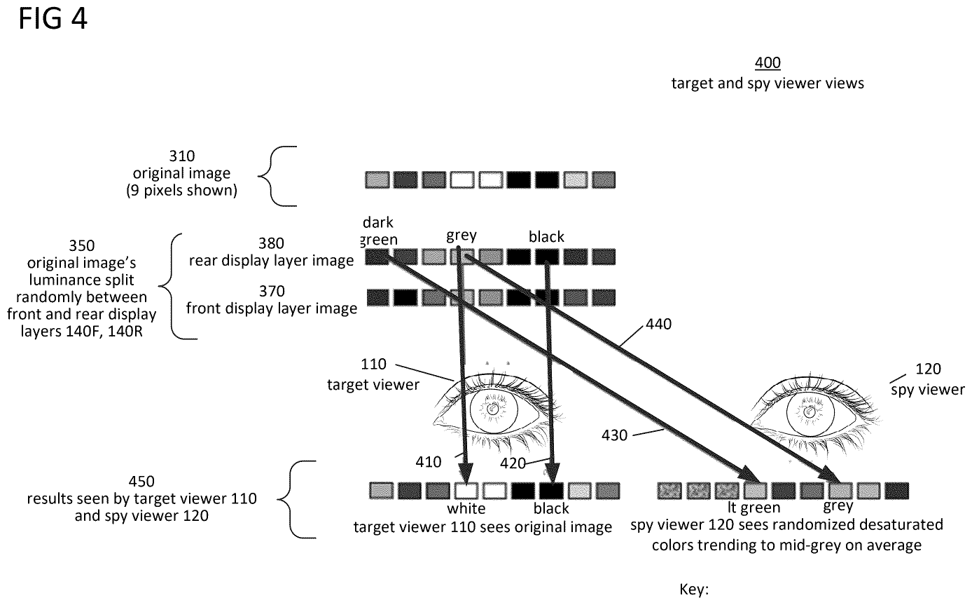

Referring to FIG. 4, target and spy viewer views 400 illustrate how the original image 310 is processed and displayed differently to the target viewer 110 and the spy viewer 120 using the dual-layer display configuration. The original image 310 shows a plurality of pixels arranged in a row. The original image 310 is processed through the step 350, which splits the luminance of each pixel randomly between the front display layer 140F and the rear display layer 140R to generate the front layer display image 370 and the rear layer display image 380.

As further shown in FIG. 4, for each pixel of the original image 310 having a luminance value L, the front layer display image 370 assigns a randomized value to the front display layer 140F where the front luminance equals a random value between zero and L. The rear layer display image 380 sets the rear display layer 140R luminance based on the front luminance to achieve a sum equal to L, such that the rear luminance equals L minus the front luminance. The randomized value may be a pseudorandom value. The randomized value may be generated independently for each pixel of the original image 310. Although the front display layer 140F is described as having randomized pixel values, in alternative implementations, the rear display layer 140R may be randomized, and the front display layer 140F values may be determined based on the randomized rear layer values.

With continued reference to FIG. 4, the target viewer 110 views the display 140 from a direct angle and sees the combination of aligned pixels from the front display layer 140F and the rear display layer 140R, resulting in the original image 310 being perceived correctly. The spy viewer 120 views the display 140 from an off-axis angle and sees misaligned pixels from the front display layer 140F and the rear display layer 140R. The spy viewer 120 perceives randomized desaturated colors trending to mid-grey on average due to the combination of unrelated random pixels from the two layers.

When the spy viewer 120 views the display 140 at a 45-degree angle, the rear pixel is offset by, for example, 20-55 pixels from the front pixel due to parallax caused by the spatial separation between the front display layer 140F and the rear display layer 140R. This parallax-induced misalignment causes pixels from the front display layer 140F to combine with spatially offset pixels from the rear display layer 140R for the spy viewer 120, resulting in the combination of two completely unrelated pixels.

As further shown in FIG. 4, viewer results 450 demonstrate the results seen by the target viewer 110 and the spy viewer 120. A first pixel combination 410 demonstrates that grey plus grey equals white as seen by the target viewer 110. A second pixel combination 420 demonstrates that black plus black equals black. A third pixel combination 430 demonstrates that dark green plus grey equals light green as perceived by the spy viewer 120. A fourth pixel combination 440 demonstrates that grey plus black equals grey. The first pixel combination 410, the second pixel combination 420, the third pixel combination 430, and the fourth pixel combination 440 illustrate how the randomized distribution of luminance between the front display layer 140F and the rear display layer 140R produces the intended image for the target viewer 110 while producing signal noise for the spy viewer 120. The left pixels on the spy viewer 120 side are undefined as they would combine the luminance of the three left-most pixels from the front display layer 140F and the three pixels from the rear display layer 140R, which are not shown in FIG. 4.

The display system 100 may be configured to display 2D text applications with privacy protection for confidential or private materials. The display system 100 may prevent users positioned at the side from viewing content displayed on the display 140. The display system 100 may selectively operate in a privacy mode in which the randomized value is assigned and a non-privacy mode in which the randomized value is not assigned. In the privacy mode, the luminance randomization is applied to split pixel values between the front display layer 140F and the rear display layer 140R. In the non-privacy mode, the display system 100 may operate without the luminance randomization. The difference between privacy mode and non-privacy mode is that, in non-privacy mode, the hardware may drive either the front display layer 140F or the rear display layer 140R, rather than operating both layers simultaneously. This configuration likely reduces power consumption and may explain why non-privacy mode is selected when privacy is not required, since privacy mode would incur an additional power penalty.

The display system 100 may ensure alternate rows of pixels are seen by either the left eye or the right eye of the target viewer 110 and not both eyes to prevent blur in 3D mode. The camera 130 may track the position of the left eye and the right eye of the target viewer 110 to align the alternate rows of pixels appropriately for each eye.

The pixel value for each pixel of the original image 310 may comprise a color value for each of a plurality of color channels. The randomization and luminance splitting described with reference to step 350 may be applied independently to each color channel of the pixel value. The front layer display image 370 and the rear layer display image 380 may each contain color values for the plurality of color channels, with the randomized distribution applied to each color channel to maintain the correct combined color for the target viewer 110 while producing randomized colors for the spy viewer 120.

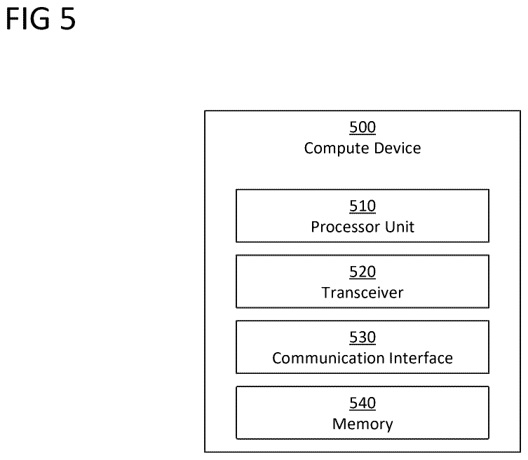

Referring to FIG. 5, a compute device 500 implements the display privacy functionality described with reference to FIG. 3 and FIG. 4. The compute device 500 may include a processor unit 510, a transceiver 520, a communication interface 530, and a memory 540. The processor unit 510 executes instructions and performs computational operations for the compute device 500, including randomizing luminance values between the front display layer 140F and the rear display layer 140R and calculating parallax adjustments based on eye-tracking information from the camera 130.

With continued reference to FIG. 5, the transceiver 520 enables transmission and reception of signals, allowing the compute device 500 to communicate with external devices or networks. The communication interface 530 provides connectivity options for the compute device 500 to exchange data with other systems or components. The memory 540 stores data and instructions used by the processor unit 510 during operation.

The memory 540 may be a non-transitory computer-readable medium storing instructions that, when executed by the processor unit 510, cause the processor unit 510 to receive the original image 310 comprising a plurality of pixels, each pixel having a pixel value. The pixel value may comprise a luminance value. The pixel value may comprise a color value for each of a plurality of color channels. The instructions stored in the memory 540 may cause the processor unit 510 to, for each pixel of the original image 310, assign a first value to the front display layer 140F and a second value to the rear display layer 140R. One of the first value or the second value may be a randomized value and the other of the first value or the second value may be determined based on the randomized value and the pixel value. The randomized value may be a pseudorandom value generated independently for each pixel.

The instructions stored in the memory 540 may cause the processor unit 510 to cause the front display layer 140F and the rear display layer 140R to display respective images based on the assigned values. The respective images may be aligned based on a position of the target viewer 110 relative to the display 140. A sum of the first value and the second value may equal the pixel value.

The instructions stored in the memory 540 may cause the processor unit 510 to receive a detected position of the target viewer 110 from the camera 130. The camera 130 may detect the position of one or more eyes of the target viewer 110. The instructions may cause the processor unit 510 to determine a pixel shift adjustment to align the respective images based on the position of the target viewer 110. The pixel shift adjustment may be computed as an x′y′ offset to align the rear layer display image 380 to the front layer display image 370 for the calculated view angle of the target viewer 110.

The instructions stored in the memory 540 may cause the processor unit 510 to selectively operate the display 140 in a privacy mode, in which the randomized value is assigned, and a non-privacy mode, in which the randomized value is not assigned. In the privacy mode, the processor unit 510 applies the luminance randomization to split pixel values between the front display layer 140F and the rear display layer 140R. In the non-privacy mode, the processor unit 510 may operate the display 140 without the luminance randomization.

A number of implementations have been described. Nevertheless, it will be understood that various modifications may be made without departing from the spirit and scope of the disclosure. Accordingly, other implementations are within the scope of the following claims.

The techniques described in this disclosure may also be illustrated in the following examples.

Example 1. A display system, comprising: a display including a front display layer and a rear display layer; and a processor configured to: receive an original image comprising a plurality of pixels, each pixel having a pixel value; for each pixel of the original image, assign a first value to the front display layer and a second value to the rear display layer, wherein one of the first value or the second value is a randomized value and the other of the first value or the second value is determined based on the randomized value and the pixel value; and cause the front display layer and the rear display layer to display respective images based on the assigned values, wherein the respective images are aligned based on a position of a viewer relative to the display.

Example 2. The display system of example 1, wherein the pixel value comprises a luminance value.

Example 3. The display system of any one or more of examples 1-2, wherein a sum of the first value and the second value equals the pixel value.

Example 4. The display system of any one or more of examples 1-3, further comprising: a camera configured to detect the position of the viewer relative to the display.

Example 5. The display system of any one or more of examples 1-4, wherein the camera is configured to detect a position of one or more eyes of the viewer.

Example 6. The display system of any one or more of examples 1-5, wherein the processor is configured to determine a pixel shift adjustment to align the respective images based on the position of the viewer.

Example 7. The display system of any one or more of examples 1-6, wherein a spatial separation between the front display layer and the rear display layer causes a parallax-induced misalignment for an off-axis viewer such that pixels from the front display layer combine with spatially offset pixels from the rear display layer.

Example 8. The display system of any one or more of examples 1-7, wherein the randomized value is a pseudorandom value.

Example 9. The display system of any one or more of examples 1-8, wherein the randomized value is generated independently for each pixel, or independently for each color channel of each pixel.

Example 10. The display system of any one or more of examples 1-9, wherein the processor comprises a graphics processing unit, a scaler, a timing controller, or image processing circuitry.

Example 11. The display system of any one or more of examples 1-10, wherein the display is configured to selectively operate in a privacy mode and a non-privacy mode.

Example 12. The display system of any one or more of examples 1-11, wherein the pixel value comprises a color value for each of a plurality of color channels.

Example 13. A non-transitory computer-readable medium storing instructions that, when executed by a processor, cause the processor to: receive an original image comprising a plurality of pixels, each pixel having a pixel value; for each pixel of the original image, assign a first value to a front display layer and a second value to a rear display layer, wherein one of the first value or the second value is a randomized value and the other of the first value or the second value is determined based on the randomized value and the pixel value; and cause the front display layer and the rear display layer to display respective images based on the assigned values, wherein the respective images are aligned based on a position of a viewer relative to a display.

Example 14. The non-transitory computer-readable medium of example 13, wherein the pixel value comprises a luminance value.

Example 15. The non-transitory computer-readable medium of any one or more of examples 13-14, wherein a sum of the first value and the second value equals the pixel value.

Example 16. The non-transitory computer-readable medium of any one or more of examples 13-15, wherein the instructions further cause the processor to receive a detected position of the viewer from a camera.

Example 17. The non-transitory computer-readable medium of any one or more of examples 13-16, wherein the instructions further cause the processor to determine a pixel shift adjustment to align the respective images based on the position of the viewer.

Example 18. The non-transitory computer-readable medium of any one or more of examples 13-17, wherein the randomized value is generated independently for each pixel, or independently for each color channel of each pixel.

Example 19. The non-transitory computer-readable medium of any one or more of examples 13-18, wherein the pixel value comprises a color value for each of a plurality of color channels.

Example 20. The non-transitory computer-readable medium of any one or more of examples 13-19, wherein the instructions further cause the processor to selectively operate the display in a privacy mode and a non-privacy mode.

Although specific aspects have been illustrated and described herein, it will be appreciated by those of ordinary skill in the art that a variety of alternate and/or equivalent implementations may be substituted for the specific aspects shown and described without departing from the scope of the present application. This application is intended to cover any adaptations or variations of the specific aspects discussed herein.

1. A display system, comprising:
a display including a front display layer and a rear display layer; and
a processor configured to:
receive an original image comprising a plurality of pixels, each pixel having a pixel value;
for each pixel of the original image, assign a first value to the front display layer and a second value to the rear display layer, wherein one of the first value or the second value is a randomized value and the other of the first value or the second value is determined based on the randomized value and the pixel value; and
cause the front display layer and the rear display layer to display respective images based on the assigned values, wherein the respective images are aligned based on a position of a viewer relative to the display.

2. The display system of claim 1, wherein the pixel value comprises a luminance value.

3. The display system of claim 1, wherein a sum of the first value and the second value equals the pixel value.

4. The display system of claim 1, further comprising:
a camera configured to detect the position of the viewer relative to the display.

5. The display system of claim 4, wherein the camera is configured to detect a position of one or more eyes of the viewer.

6. The display system of claim 1, wherein the processor is configured to determine a pixel shift adjustment to align the respective images based on the position of the viewer.

7. The display system of claim 1, wherein a spatial separation between the front display layer and the rear display layer causes a parallax-induced misalignment for an off-axis viewer such that pixels from the front display layer combine with spatially offset pixels from the rear display layer.

8. The display system of claim 1, wherein the randomized value is a pseudorandom value.

9. The display system of claim 1, wherein the randomized value is generated independently for each pixel, or independently for each color channel of each pixel.

10. The display system of claim 1, wherein the processor comprises a graphics processing unit, a scaler, a timing controller, or image processing circuitry.

11. The display system of claim 1, wherein the display is configured to selectively operate in a privacy mode and a non-privacy mode.

12. The display system of claim 1, wherein the pixel value comprises a color value for each of a plurality of color channels.

13. A non-transitory computer-readable medium storing instructions that, when executed by a processor, cause the processor to:
receive an original image comprising a plurality of pixels, each pixel having a pixel value;
for each pixel of the original image, assign a first value to a front display layer and a second value to a rear display layer, wherein one of the first value or the second value is a randomized value and the other of the first value or the second value is determined based on the randomized value and the pixel value; and
cause the front display layer and the rear display layer to display respective images based on the assigned values, wherein the respective images are aligned based on a position of a viewer relative to a display.

14. The non-transitory computer-readable medium of claim 13, wherein the pixel value comprises a luminance value.

15. The non-transitory computer-readable medium of claim 13, wherein a sum of the first value and the second value equals the pixel value.

16. The non-transitory computer-readable medium of claim 13, wherein the instructions further cause the processor to receive a detected position of the viewer from a camera.

17. The non-transitory computer-readable medium of claim 13, wherein the instructions further cause the processor to determine a pixel shift adjustment to align the respective images based on the position of the viewer.

18. The non-transitory computer-readable medium of claim 13, wherein the randomized value is generated independently for each pixel, or independently for each color channel of each pixel.

19. The non-transitory computer-readable medium of claim 13, wherein the pixel value comprises a color value for each of a plurality of color channels.

20. The non-transitory computer-readable medium of claim 13, wherein the instructions further cause the processor to selectively operate the display in a privacy mode and a non-privacy mode.
